(19) United States
(12) Patent Application Publication
(10) Pub. No.: US 2010/0270425 A1
(43) Pub. Date: Oct. 28, 2010

(54) APPARATUS AND SYSTEM FOR PROVIDING SURVEILLANCE OF AN AREA OR A SPACE

(76) Inventor: Yonatan Zur, Tel Aviv (IL)

Correspondence Address: EITAN MEHULAL LAW GROUP, 10 Abba Eban Blvd. PO Box 2081, Herzlia, 46120, IL

(21) Appl. No.: 12/449,872

(22) PCT Filed: Aug. 31, 2009
(86) PCT No.: PCT/IB2009/053791

§ 371 Date: Sep. 1, 2009

(30) Foreign Application Priority Data
Sep. 2, 2008 (IL) 193847

(51) Int. Cl. B64B 1/50; B64B 1/40; B64B 1/42; F42B 4/08

(52) U.S. Cl. 244/33; 244/31; 102/335

(57) ABSTRACT

The present invention is an apparatus and system for providing surveillance of an area or a space. According to some embodiments of the present invention there may be provided a housing containing a deployable and inflatable surveillance balloon, which balloon may elevate and/or support a surveillance payload including one or more sensor assemblies. Data collected by the sensors may be transmitted to a user interface which may display the data to a user.

### FIELD OF THE INVENTION

The present invention generally relates to the field of surveillance. More specifically, the present invention relates to an apparatus and system for providing surveillance of an area or space.

### BACKGROUND

Surveillance generally refers to monitoring or observing a person or a group of people from a certain distance, frequently, although not necessarily, comprising the use of electronic equipment and/or other technological devices. Surveillance equipment is typically used in warfare and/or in counter-insurgency operations to monitor the activities of an enemy from a distance, thereby reducing the risk of confrontations which may result in injury, and possible death, to friendly personnel. Surveillance equipment may also be used to monitor hazardous situations from a distance, such as for example, as may be associated with chemical hazards, explosive hazards, and the like, so as to provide advance information to personnel responsible for controlling the hazards. Other applications may include search and rescue missions, police operations, and homeland security activities.

Surveillance operations occasionally rely on surveillance balloons for monitoring from afar. A first use of surveillance balloons in warfare is thought to be during the US Civil War, when officers were sent up on large balloons with baskets to direct artillery fire from above. Today's surveillance balloons are relatively small in comparison, and typically may include a payload with a video camera, a thermal imager, a laser range finder, and/or other sophisticated equipment adapted to record video images, and sometimes audio, and to transmit the images (and audio) back to a monitoring station. Furthermore, in some cases, the surveillance balloons may be robotic adapted to operate, including move, without receiving control inputs from the monitoring station.

As technological advancements contribute to electronic component size down-scaling and increased performance, surveillance balloons are also experiencing a reduction in size. For example, see—U.S. Pat. No. 7,341,224 B1 “Miniature Expendable Surveillance Balloon System”, which describes “a miniature surveillance balloon system that can be used in military and public safety situations for real-time observations”. They are small, low-cost and expendable, and typically are deployed in clusters. Balloons may act individually or alternately clusters may act robotically (in unison) without command input at times. Video surveillance information is preprocessed and then sent via wireless communications links. Batteries and/or gas cylinders may be selectively jettisoned to facilitate vertical movement. Balloons may optionally have thruster mechanisms to facilitate lateral movement which may in some embodiments be powered by a source of combustible gas which is also used for providing lift.”

### SUMMARY OF THE INVENTION

According to some embodiments of the present invention, there is provided a surveillance apparatus comprised of one or more of the following components:
a. A housing which, according to some embodiments of the present invention, may be of a size, shape and weight that can be held and thrown by a human using one hand;
b. A deployable surveillance balloon adapted to reside within the housing prior to deployment, adapted to automatically exit the housing during deployment and being further adapted to support a surveillance payload after deployment;
c. A deployment mechanism adapted to cause deployment of said balloon from said housing upon occurrence of a predefined condition. The predefined condition may be the completion of a deployment initiating sequence, wherein the deployment initiating sequence may include one or more of the following events: (a) a user releasing a safety, (b) a user engaging a deployment initiating mechanism, (c) a user throwing said housing, (d) said housing being launched from a launcher, (e) impact detection, (f) acceleration detection, (g) the lapsing of a predefined delay, (h) the lapsing of a user selected delay, (i) a radio signal being received, and (j) a pyrotechnical event, such as a fuse burning or a charge detonating.
d. The deployment mechanism may be functionally associated with one or more devices selected from the group consisting of: (a) an accelerometer, (b) an impact detector/sensor, (c) a fixed timer, (d) an adjustable timer, and (e) a deployment initiating mechanism, (f) a mechanical delay mechanism, (g) an electronic delay mechanism, (h) a safety mechanism (i) a radio signal receiver, and (j) a pyrotechnical mechanism, such as a fuse or a charge;
e. A surveillance payload which may include one or more sensor assemblies and/or a payload communication module.
f. One or more sensor assemblies which may include one or more sensors selected from the group consisting of: (a) image sensors, (b) thermal sensors, (c) audio sensors, (d) location sensors, (e) altitude sensors, (f) a compass, and (g) motion sensors;
g. One or more communication modules, located in the housing and/or the surveillance payload, which communication modules may be adapted to transmit data collected by the sensors to one or more user interfaces and/or one or more remote monitoring stations.
h. An illumination source, which illumination source may reside in the surveillance payload and/or the housing;
i. An anchor line which may be adapted to anchor the deployable surveillance balloon to the housing after deployment;
j. An explosive charge designed to create a loud noise and/or a bright flash of light upon explosion—A “flash” charge;
k. Processing circuitry which may be adapted to process data collected by the sensors;
l. A lighter-than-air gas source which may be adapted to provide lighter-than-air gas for inflation of the surveillance balloon during and/or after deployment; and
m. Ancillary components which may facilitate the operation of the system, such as power sources, gas lines, wires, control circuitry, databases, displays, regulators, latches, springs, levers, gaskets, etc.

According to further embodiments of the present invention, there may be provided a surveillance system comprising one or more of the following components:
a. One or more user interface devices which may be adapted to receive and display to a user surveillance data and, according to some further embodiments of the present invention, may be further adapted to receive and transmit user commands and to store surveillance data;
b. A housing which, according to some embodiments of the present invention, may be of a size, shape and weight that can be held and thrown by a human using one hand;
c. A deployable surveillance balloon adapted to reside within the housing prior to deployment, adapted to automatically exit the housing during deployment and being further adapted to support a surveillance payload after deployment;
d. A deployment mechanism adapted to cause deployment of said balloon from said housing upon occurrence of a predefined condition. The predefined condition may be the completion of a deployment initiating sequence, wherein the deployment initiating sequence may include one or more of the following events: (a) a user releasing a safety, (b) a user engaging a deployment initiating mechanism, (c) a user throwing said housing, (d) said housing being launched from a launcher, (e) impact detection, (f) acceleration detection, (g) the lapsing of a predefined delay, (h) the lapsing of a user selected delay, (i) a radio signal being received and (j) a pyrotechnical event, such as a fuse burning or a charge detonating and more but not limited to these examples.
e. The deployment mechanism may be functionally associated with one or more devices selected from the group consisting of: (a) an accelerometer, (b) an impact detector/sensor, (c) a fixed timer, (d) an adjustable timer, and (e) a deployment initiating mechanism, (f) a mechanical delay mechanism, (g) an electronic delay mechanism, (h) a safety mechanism (i) a radio signal receiver and (j) a pyrotechnical mechanism, such as a fuse or a charge and more but not limited to these examples;
f. A surveillance payload which may include one or more sensor assemblies and/or a payload communication module.
g. One or more sensor assemblies which may include one or more sensors selected from the group consisting of: (a) image sensors, (b) thermal sensors, (c) audio sensors, (d) location sensors, (e) altitude sensors, (f) a compass and (g) motion sensors;
h. One or more communication modules, located in the housing and/or the surveillance payload, which communication modules may be adapted to transmit data collected by the sensors to the user interface device(s) and/or one or more remote monitoring stations.
i. An illumination source, which illumination source may reside in the surveillance payload and/or the housing;
j. An anchor line which may be adapted to anchor the deployable surveillance balloon to the housing after deployment;
k. An explosive charge designed to create a loud noise and/or a bright flash of light upon explosion, i.e., A “flash” charge;
l. Processing circuitry which may be adapted to process data collected by the sensors;
m. A lighter-than-air gas source which may be adapted to provide lighter-than-air gas for inflation of the surveillance, balloon during and/or after deployment;
n. A launcher which may be adapted to launch a housing prior to deployment; and
o. Ancillary components which may facilitate the operation of the system, such as power sources, gas lines, wires, control circuitry, databases, displays, regulators, latches, springs, levers, gaskets, etc.

### BRIEF DESCRIPTION OF THE DRAWINGS

FIG. 1A: Is an illustration of an exemplary surveillance balloon, in operation, after deployment in an outdoor environment, in accordance with some embodiments of the present invention.

FIG. 2: Is an illustration of an exemplary surveillance balloon, in operation, after deployment in an indoor environment, in accordance with some embodiments of the present invention.

FIG. 3A: Is a block diagram of an exemplary housing, before deployment, according to some embodiments of the present invention.

FIG. 3B+3C: Are illustrations of the outside of an exemplary housing, before deployment, according to some embodiments of the present invention.

FIG. 3D: Is an illustration of a cross-section of an exemplary housing, before deployment, according to some embodiments of the present invention.

FIG. 3E: Is an illustration of some of the inside of an exemplary housing, before deployment, according to some embodiments of the present invention.

FIG. 3F: Is an illustration of the delay mechanism of an exemplary housing, before deployment, according to some embodiments of the present invention.

FIG. 4: Is an illustration of an exemplary conic surveillance balloon, according to some embodiments of the present invention.

FIG. 5A: Is a block diagram of an exemplary surveillance payload, according to some embodiments of the present invention.

FIG. 5B: Is an illustration of the outside of an exemplary surveillance payload, according to some embodiments of the present invention.

FIG. 6A: Is a block diagram of an exemplary user interface, according to some embodiments of the present invention.

FIG. 6B+6C: Are illustrations of the outside of an exemplary user interface, according to some embodiments of the present invention.

FIG. 7A: Is an exemplary flowchart including steps of deployment of a surveillance balloon, according to some embodiments of the present invention.

FIG. 7B-7G: Are illustrations of exemplary stages of deployment of a surveillance balloon, according to some embodiments of the present invention.

FIG. 8A-8C: Are illustrations of exemplary housings, according to some exemplary embodiments of the present invention.

FIG. 9: Is an illustration of the inside of an exemplary housing, before deployment, according to some exemplary embodiments of the present invention.

FIG. 10A+10B: Are illustrations of exemplary surveillance balloons supporting exemplary surveillance payloads, after deployment, according to some exemplary embodiments of the present invention.

FIG. 11: Is an illustration of an exemplary user interface, according to some exemplary embodiments of the present invention.

FIG. 12: Is an exemplary flowchart including steps of deployment of a surveillance balloon, according to some exemplary embodiments of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined. Today's IP networking represents a synthesis of two developments that began in the 1970s, namely LANs (Local Area Networks) and the Internet, both of which have revolutionized computing.

The Internet Protocol suite—like many protocol suites—can be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP reference model consists of four layers.

Layers in the Internet Protocol Suite

The IP suite uses encapsulation to provide abstraction of protocols and services. Generally a protocol at a higher level uses a protocol at a lower level to help accomplish its aims. The Internet protocol stack has never been altered, by the IETF, from the four layers defined in RFC 1122. The IETF makes no effort to follow the seven-layer OSI model and does not refer to it in standards-track protocol specifications and other architectural documents.

| | |
|---|---|
| 4. Application | DNS, TFTP, TLS/SSL, FTP, Gopher, HTTP, IMAP, |
| | IRC, NNTP, POP3, SIP, SMTP, SNMP, SSH, |
| | TELNET, ECHO, RTP, PNRP, rlogin, ENRP |
| | Routing protocols like BGP, which for a |
| | variety of reasons run over TCP, may also |
| | be considered part of the application or |
| | network layer. |
| 3. Transport | TCP, UDP, DCCP, SCTP, IL, RUDP |
| 2. Internet | Routing protocols like OSPF, which run over |
| | IP, are also to be considered part of the |
| | network layer, as they provide path selection. |
| | ICMP and IGMP run over IP and are considered |
| | part of the network layer, as they provide |
| | control information. |
| | IP (IPv4, IPv6) |
| | ARP and RARP operate underneath IP but above |
| | the link layer so they belong somewhere in |
| | between. |
| 1. Network access | Ethernet, Wi-Fi, token ring, PPP, SLIP, FDDI, |
| | ATM, Frame Relay, SMDS |

It should be understood that any topology, technology and/or standard for computer networking (e.g. mesh networks, infiniband connections, RDMA, etc.), known today or to be devised in the future, may be applicable to the present invention.

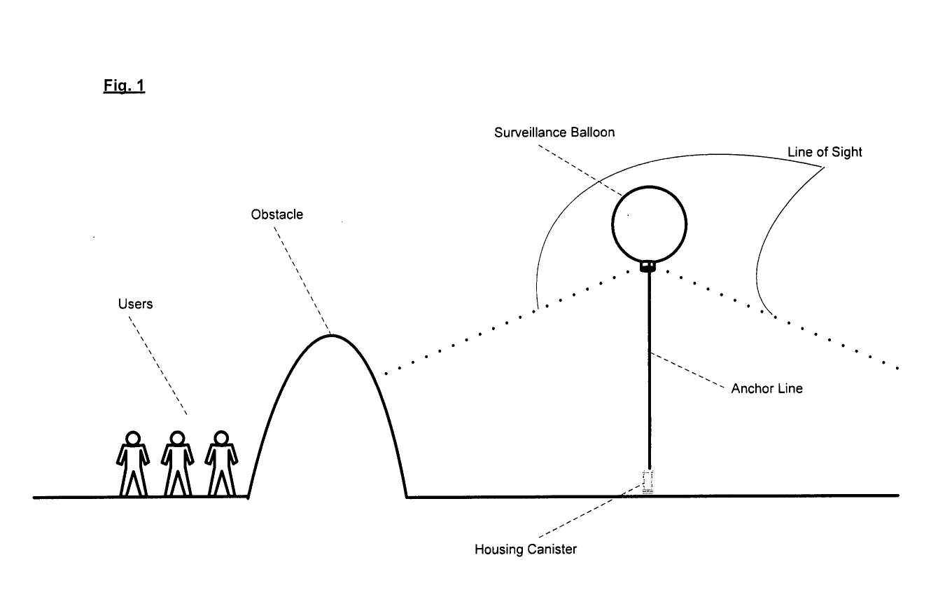

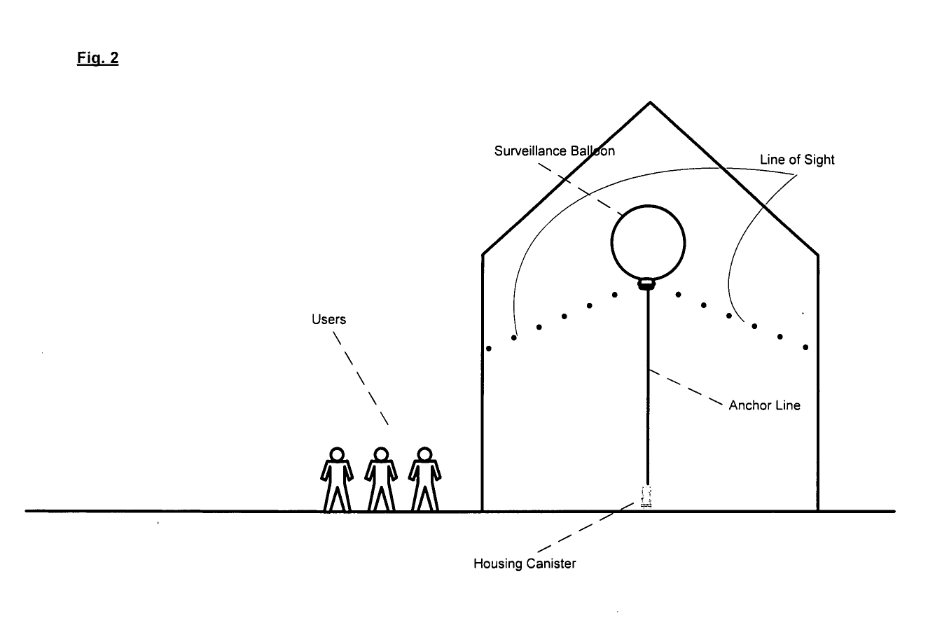

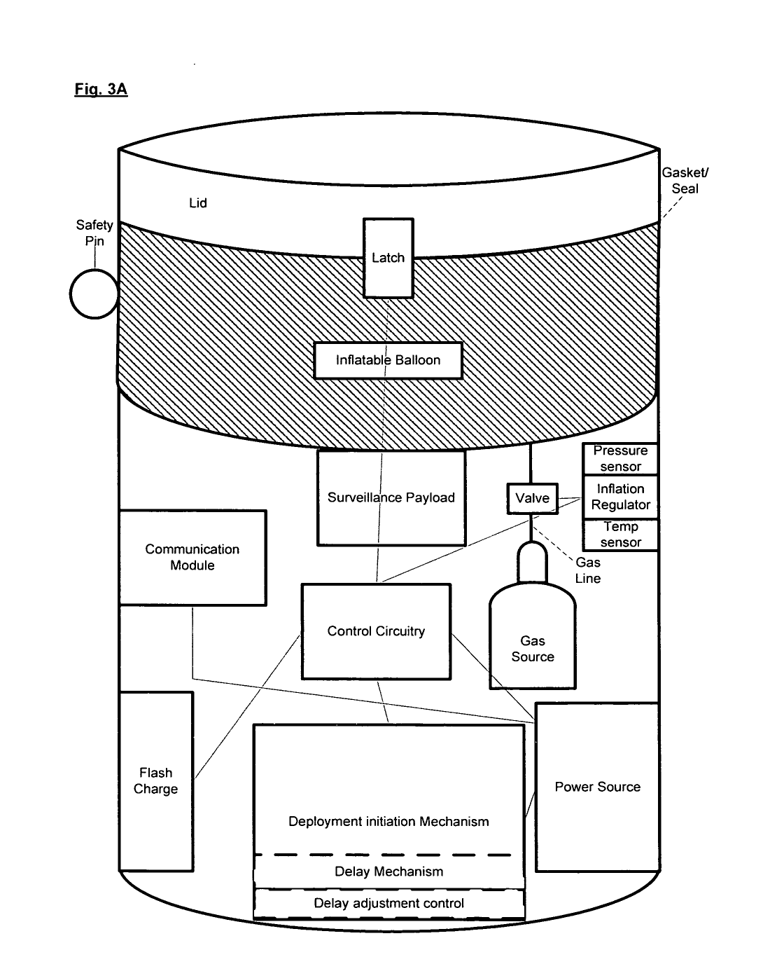

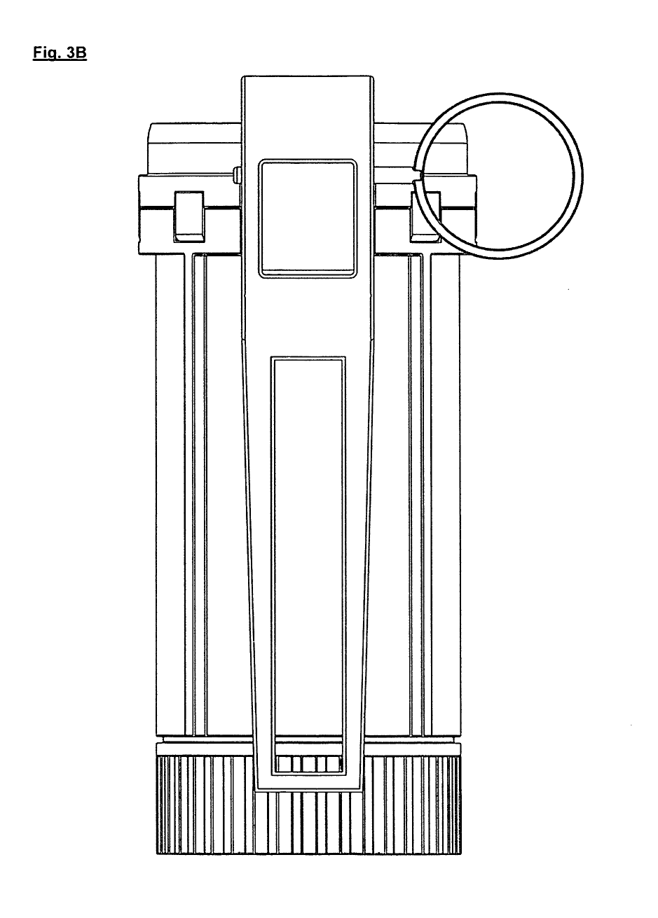

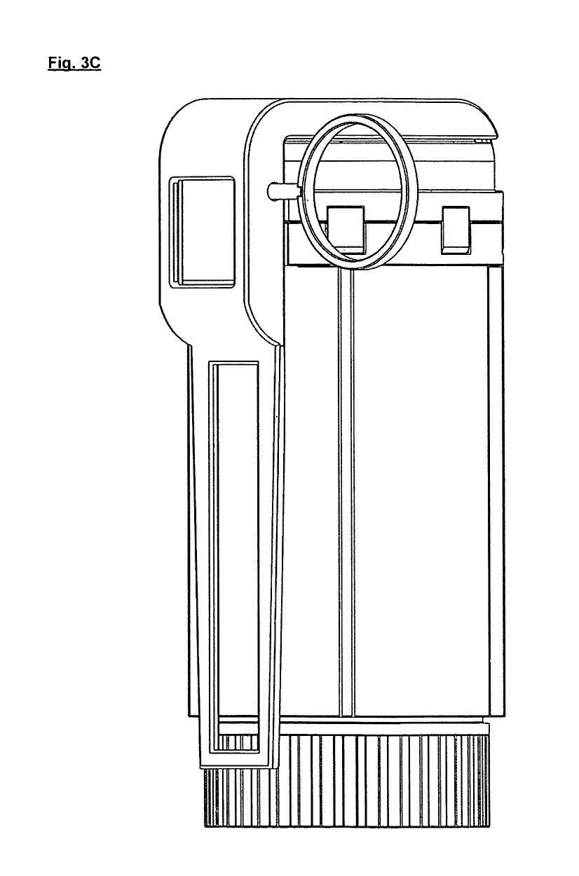

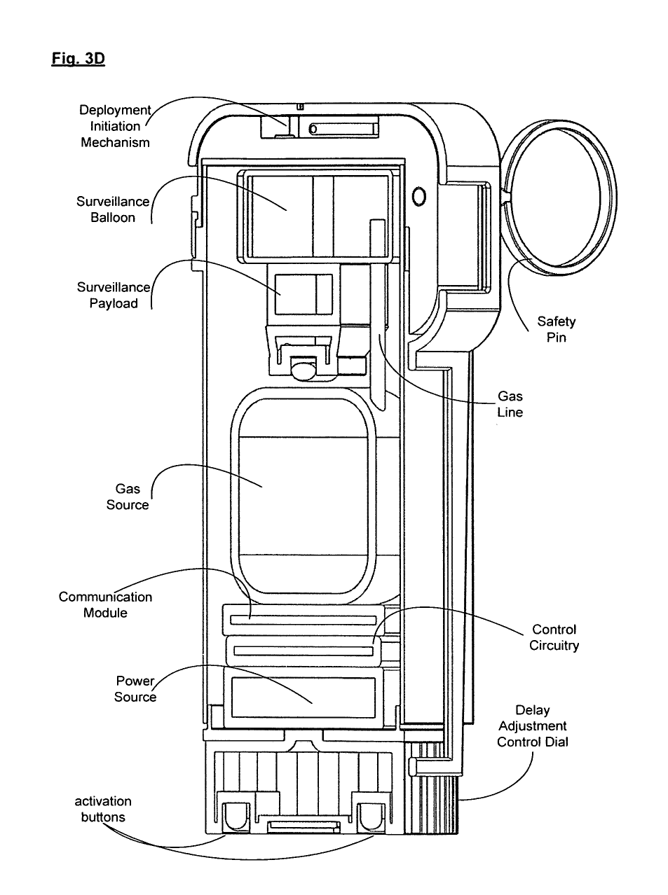

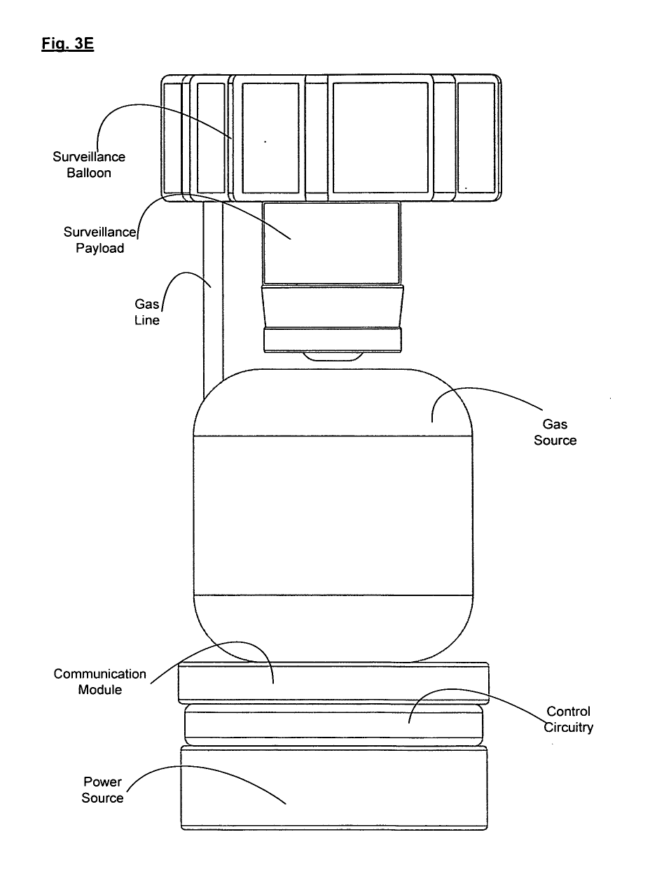

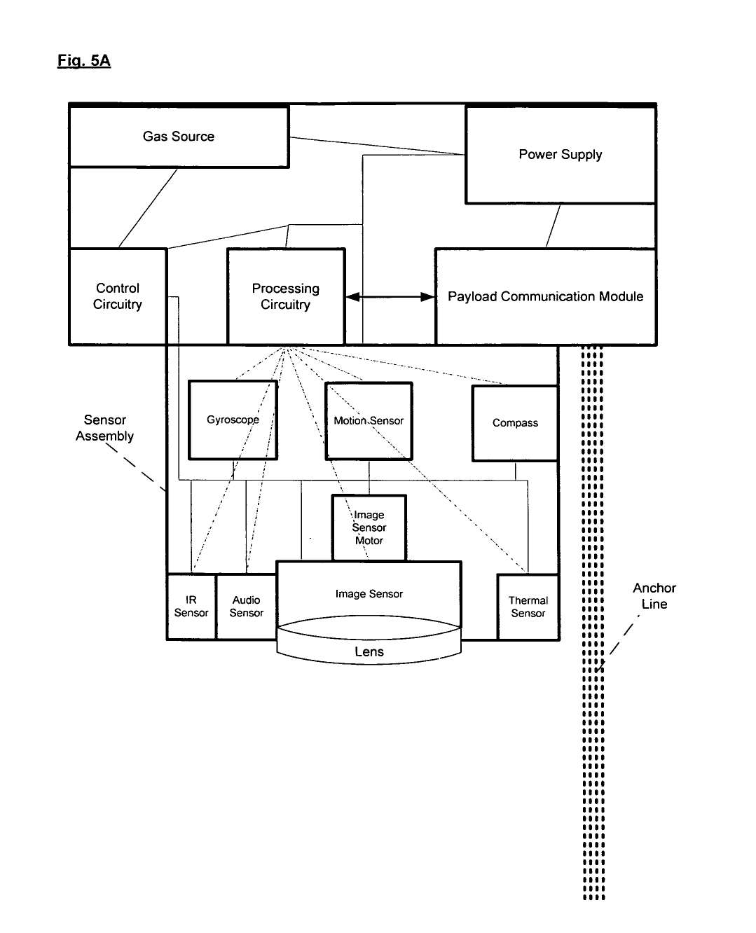

The present invention is an apparatus and system for providing surveillance of an area or a space. According to some embodiments of the present invention there may be provided a housing (examples of which can be seen in FIG. 3(A-C)) containing a deployable and inflatable surveillance balloon (an example of which can be seen in FIG. 1-2), which balloon may elevate and/or support a surveillance payload (an example of which can be seen in FIG. 5(A+B)) including one or more sensor assemblies (an example of which can be seen in FIG. 5A). Each of one or more sensor assemblies may consist of one or more sensors, such as image sensors, thermal sensors, motion sensors, audio sensors, electromagnetic sensors, or any other sensor known today or to be devised in the future (see FIG. 5A).

According to some embodiments of the present invention, a sensor assembly may include image sensors, such as a still, video, IR, InGaAs (indium gallium arsenide) and/or CCD camera, which camera(s) may include a wide angle lens. The camera may be adapted to point downward and capture a 360° view of the area below it. According to further embodiments of the present invention, the camera may point sideways-and/or may be adapted to be adjusted to point in different directions. There may also be provided a controllable actuator (see FIG. 5A) to control, during its operation, the direction the camera is pointed and/or other aspects of the cameras function, such as an electric motor. According to yet further embodiments of the current invention, there may be provided an IR and/or other illumination device located in the surveillance payload and/or the housing, which illumination device may be activated when extra illumination is desired.

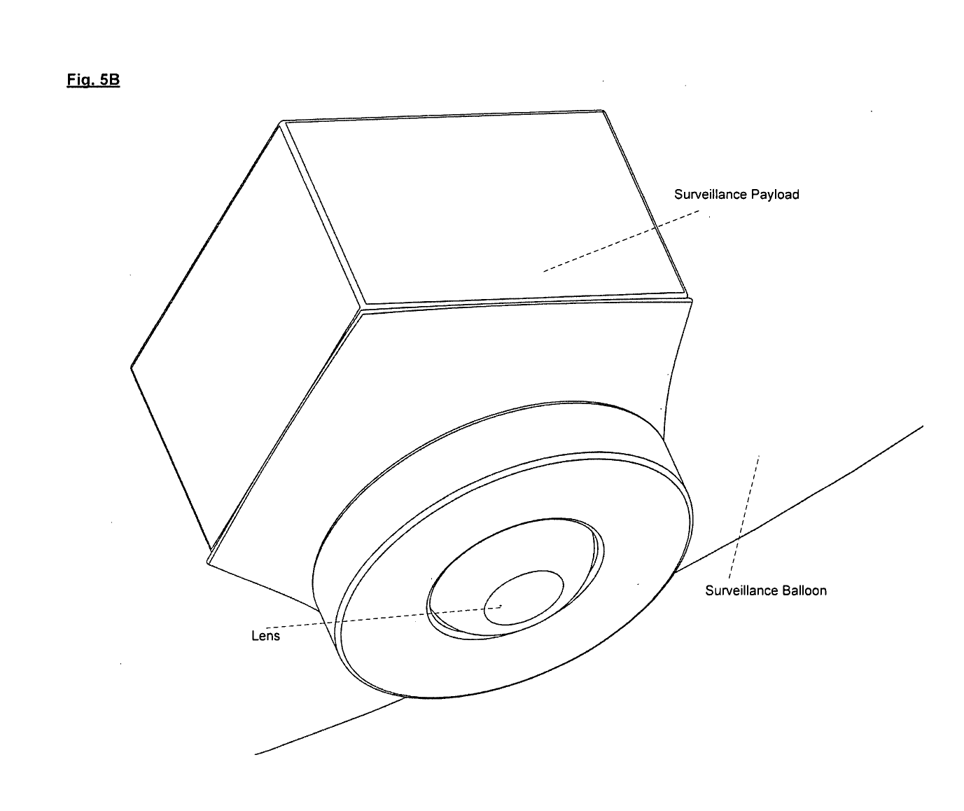

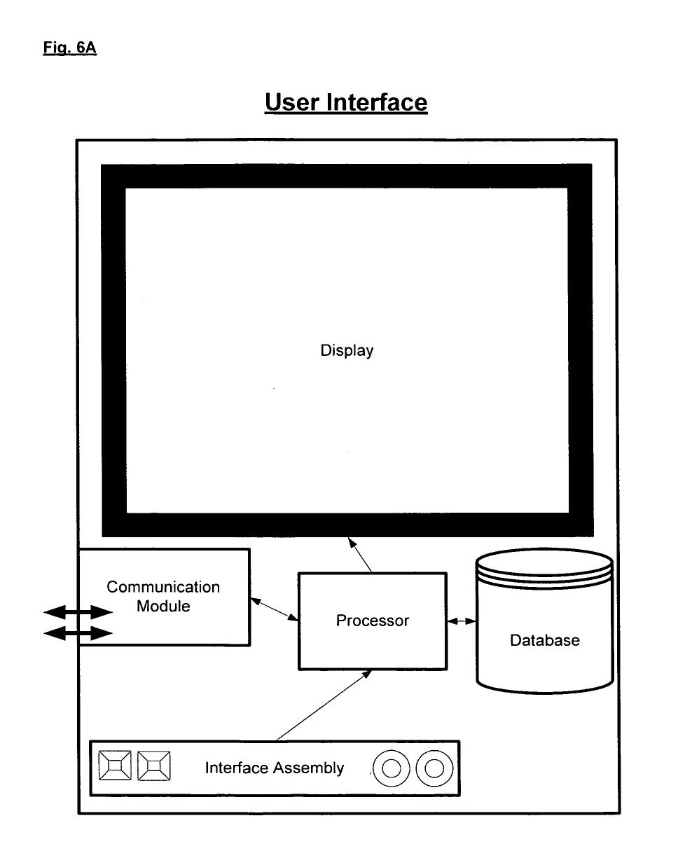

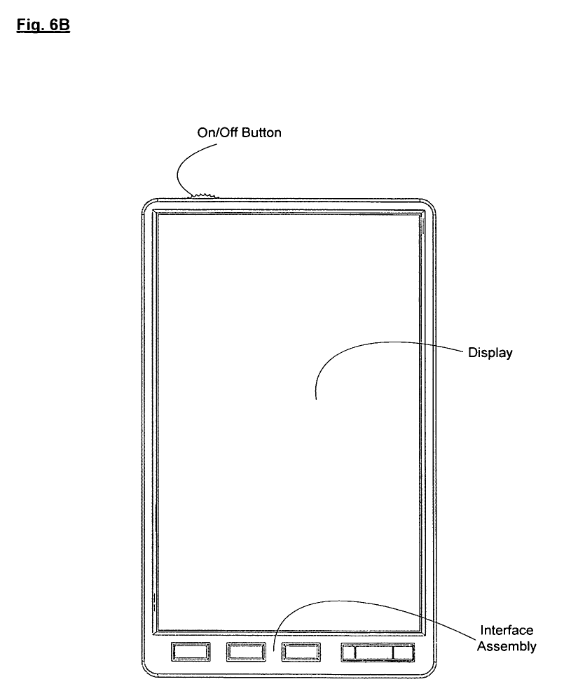

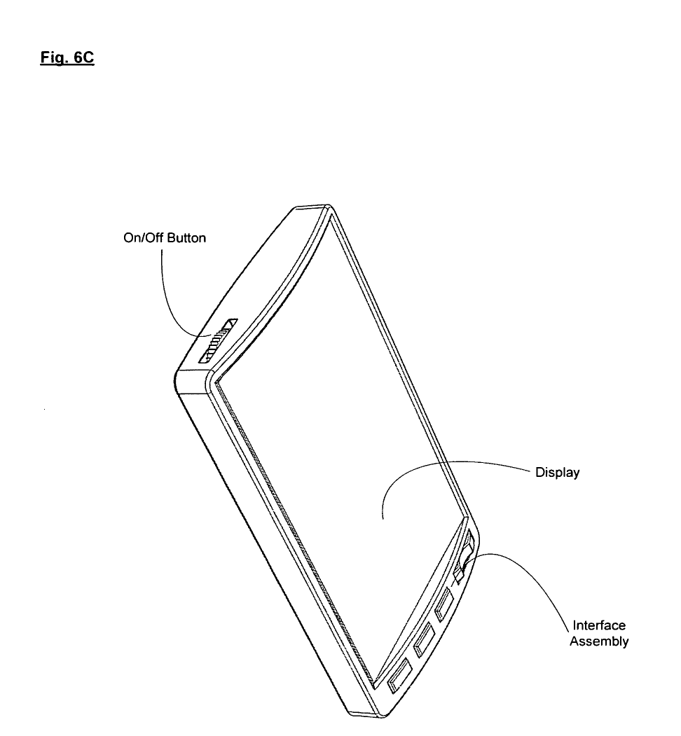

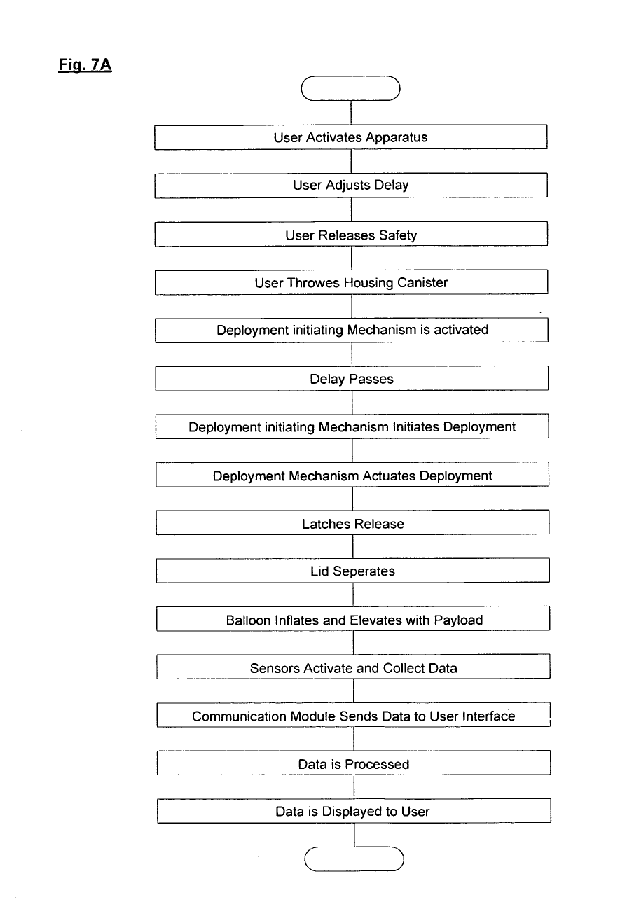

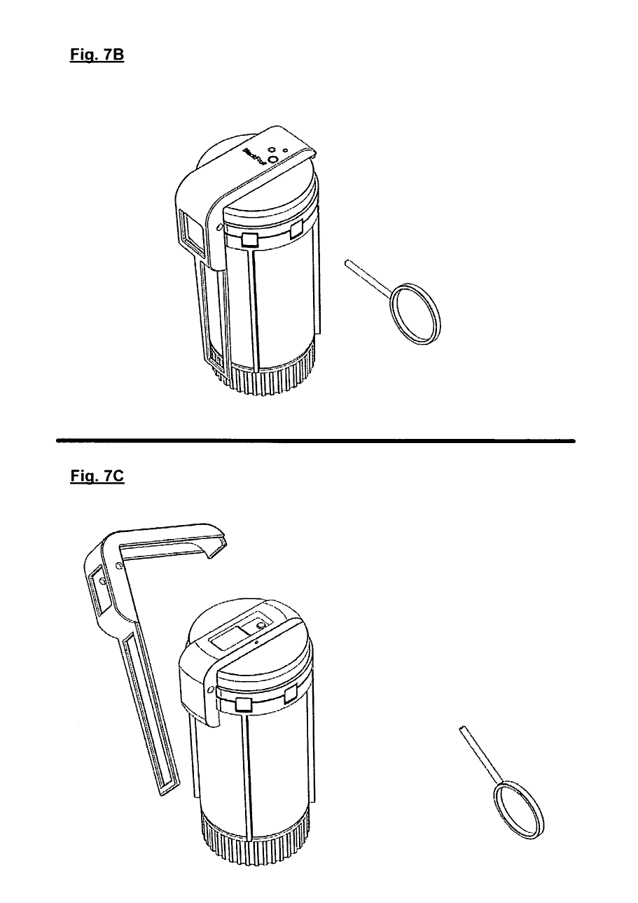

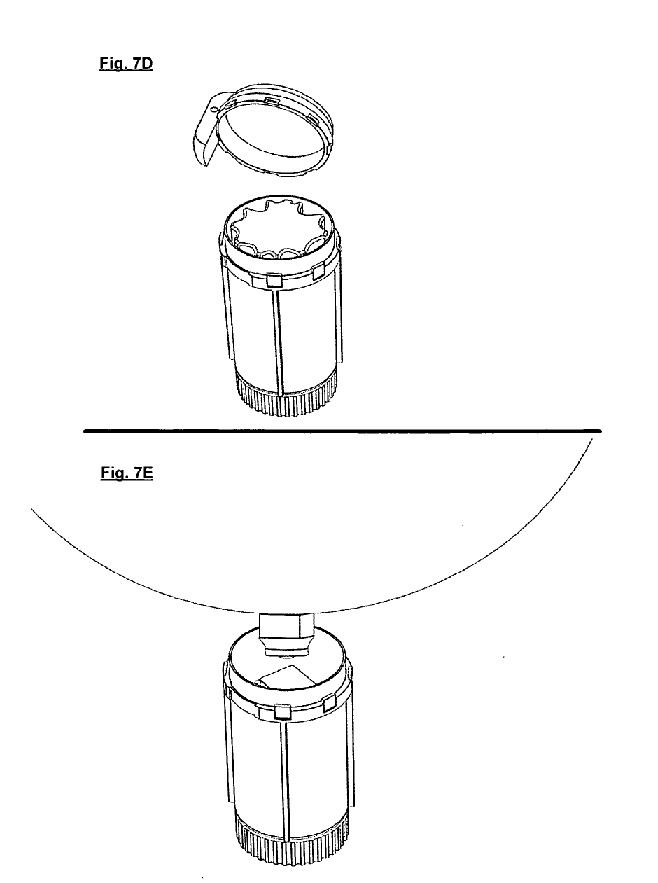

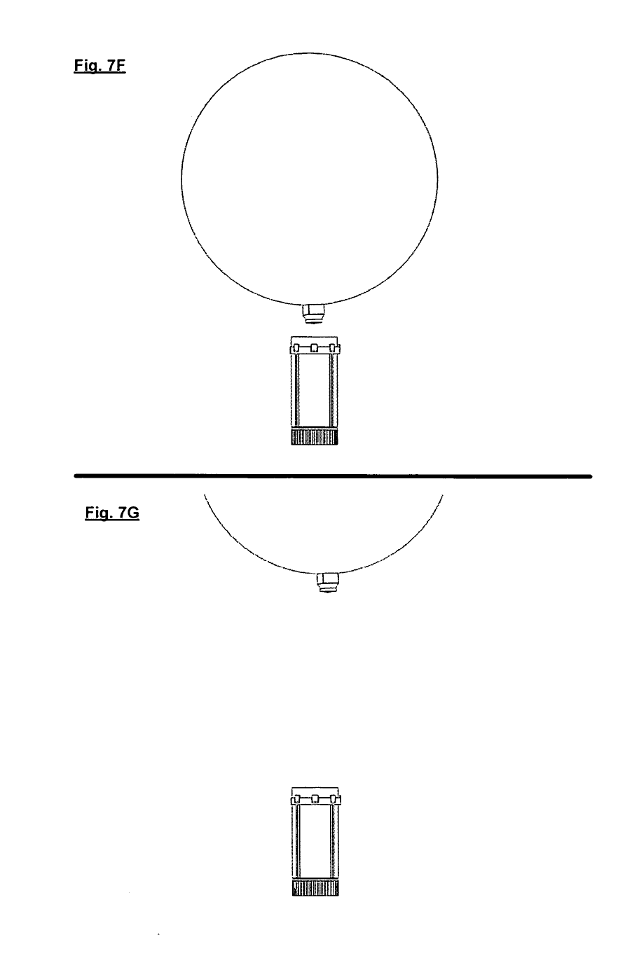

According to some embodiments of the present invention, the surveillance payload may further contain a payload communication module (see FIG. 5A), which payload communication module may be adapted to communicate, intermittently or substantially continuously, data collected by the sensors to a user interface (an example of which can be seen in FIG. 6(A-C)) and/or a remote monitoring station by any type of wireless communication, such as RF, WLAN, WiFi, WPAN, Wimax, MBWA, WRAN, IR, Bluetooth and/or any other form of wireless communication known today or to be devised in the future. According to further embodiments of the present invention, the payload communication module may be adapted to communicate data collected by the sensors, intermittently or substantially continuously, to a housing communication module (see FIG. 3A) residing in the housing, which housing communication module may be adapted to relay the data to a user interface and/or a remote monitoring station. According to yet further embodiments of the present invention, the payload communication module may be adapted to receive commands from a user interface, a remote monitoring station (either directly and/or via the housing communication module) and/or from housing control circuitry (an example of which can be seen in FIG. 3A) contained within the housing. The payload communication module may be further adapted to relay received commands to payload control circuitry (an example of which can be seen in FIG. 5A) contained within the surveillance payload.

According to some embodiments of the present invention, the payload control circuitry may be adapted to control aspects of the sensors operation, electrical and mechanical components of the surveillance payload inflation and deflation of the surveillance balloon, i.e. control elevation, the direction that the surveillance payload is facing, the rate that information is processed and/or other aspects of the surveillance payload operation.

According to some embodiments of the present invention, the surveillance payload may further contain a power source (an example of which can be seen in FIG. 5A) adapted to provide power to the various components contained within the surveillance payload. The power source may be a DC power source, such as a battery, which DC power source may be rechargeable or disposable.

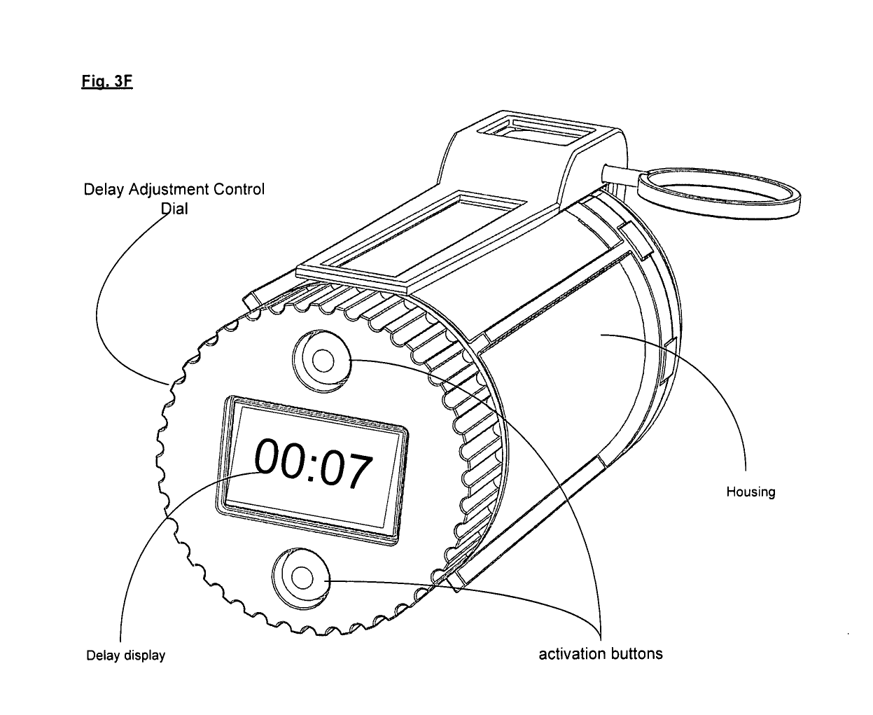

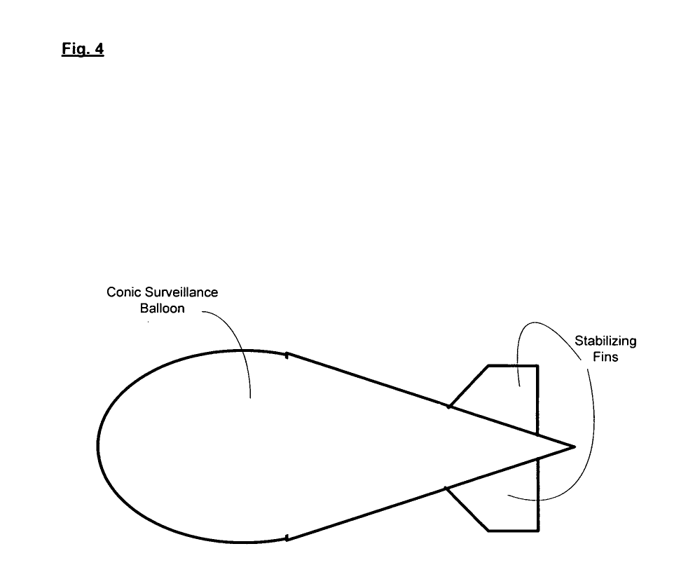

According to some embodiments of the present invention, the surveillance payload may be elevated and/or supported while in the air by an inflatable surveillance balloon to which it may be attached directly or suspended from by means capable of withstanding the tensions created between the surveillance payload and the surveillance balloon, such as strings (natural or synthetic), wires, rods, any other suitable means or any combination thereof. The surveillance balloon may be inflated with any lighter than air gas, such as helium, hydrogen or any other lighter than air gas known today or to be discovered in the future. The surveillance balloon may be constructed from rubber, plastic, metalized plastic, nylon, aluminum foil, PVC (polyvinyl chloride), fabric, tarpaulin, composite materials, any other suitable material or any combination thereof. According to yet further embodiments of the present invention, the surveillance balloon may be transparent, camouflaged or otherwise have a less detectable appearance. According to further embodiments of the present invention, the surveillance balloon may be aerodynamically shaped, such as conically shaped and may also include fins for stabilization (an example of which can be seen in FIG. 4).

According to some embodiments of the present invention, prior to deployment, the inflatable surveillance balloon, along with the surveillance payload, may be contained and/or carried within a housing (examples of which can be seen in FIG. 3(A-C)). According to some embodiments of the present invention, the surveillance balloon may be pre-inflated with a lighter than air gas and compressed to fit within the housing, so that upon deployment from the housing, the surveillance balloon may expand to its original size creating the necessary buoyancy to elevate and/or support the surveillance payload. According to further embodiments of the present invention, the surveillance balloon may be contained within the housing prior to deployment in a deflated state and may be inflated upon deployment through a gas line (examples of which can be seen in FIG. 3 (A-E)) with a lighter than air gas released from a compressed gas source (examples of which can be seen in FIG. 3 (A-E)) also contained within the housing and connected to the gas line via a valve (an example of which can be seen in FIG. 3A). According to yet further embodiments of the present invention, the deflated balloon may be inflated with a lighter than air gas produced by a chemical reaction actuated within the housing, such as a combining of appropriate chemicals stored separately within the housing. According to further embodiments of the present invention, the compressed gas housing or other lighter than air gas source may reside within the surveillance payload (an example of which can be seen in FIG. 5A).

According to some embodiments of the present invention, there may be provided an inflation regulator (an example of which can be seen in FIG. 3A), which inflation regulator may regulate the inflation of the surveillance balloon. According to further embodiments of the present invention, the inflation regulator may be functionally associated with environmental sensors (examples of which can be seen in FIG. 3A), such as temperature and pressure sensors and may be adapted to regulate the inflation of the surveillance balloon in accordance with data received from the environmental sensors.

According to some embodiments of the present invention, prior to deployment of the surveillance balloon, the housing may be sealed to be air and water tight. The housing may also be constructed to be shockproof, such as will reduce the likelihood of accidental deployment of the surveillance balloon and/or damage to the components contained within in rough conditions, during movement, under pressure and/or in cases of accidental impact with other objects. According to some embodiments of the present invention, the housing may be of a size, shape and weight that allow it to be hand held and thrown over a distance by a human, similar to a grenade (see FIG. 3B). For example, the housing may be cylindrical in shape, 15-50 cm tall, 10-30 cm in diameter and weigh 200-700 grams (prior to deployment), so that a human may be able to toss the housing a distance of up to 50 meters on flat terrain.

According to some embodiments of the present invention, the housing may include a latching and/or locking system (an example of which can be seen in FIG. 3A) to secure the balloon and its payload therein, until deployment. The latching and/or locking system may be unlocked/unlatched upon deployment, by electronic, pyrotechnic and/or mechanical means, allowing the inflating/expanding surveillance balloon to exit and/or detach itself from the housing, possibly by separation of portions of the housing, such as the lid, and subsequently elevate along with the surveillance payload. According to some embodiments of the present invention, the force created by the expanding surveillance balloon may assist in or cause the separation of the relevant portion of the housing, e.g. the housing lid.

According to some embodiments of the present invention, there may be provided a deployment initiating mechanism (examples of which can be seen in FIGS. 3A & 3D) that may be adapted to initiate the deployment of the surveillance balloon and payload from the housing. The deployment initiating mechanism may be based on a mechanical mechanism, an electronic mechanism, an acceleration and/or impact sensor mechanism, a pyrotechnic mechanism (such as a fuse or explosive charge), remote radio activation or any combination thereof. According to some embodiments of the present invention, the deployment initiating mechanism may include a delay mechanism (an example of which can be seen in FIG. 3A), which delay mechanism may be adapted to delay the deployment of the surveillance balloon after actuation by a user and may be mechanical, pyrotechnic (such as a fuse) and/or digital. According to further embodiments of the present invention, the length of the delay may be adjustable and may be displayed on a display located on the housing (an example of which can be seen in FIG. 3F) and/or on the user interface. According to yet further embodiments of the present invention, there may be provided a safety pin (examples of which can be seen in FIG. 3(B-D)), which safety pin may prevent the activation of the deployment initiating mechanism until removed, similar to a grenade actuating mechanism.

According to some embodiments of the present invention, the deployment initiating mechanism may trigger the deployment of the surveillance balloon by mechanical means (by use of springs, levers and the like), pyrotechnic means, electric means or a combination thereof. In response to receiving a signal from the deployment initiating mechanism, the housing control circuitry may be adapted to activate and actuate the relevant components of the housing to cause deployment of the surveillance balloon and payload. The housing control circuitry may be further adapted to activate and control one or more of the components of the housing and/or the surveillance payload, possibly by means of the housing communication module.

According to further embodiments of the present invention, the housing may further include a power supply to power various circuits and actuators.

According to some embodiments of the present invention, there may be provided a user interface (examples of which can be seen in FIG. 6(A-C)) comprising; (i) one or more displays; (ii) an interface assembly; (iii) processing circuitry; (iv) one or more communication modules; and (v) a database. The user interface may be hand held or otherwise portable and may be adapted to display to a user data, such as images, video, audio, etc., collected by the sensors contained in the surveillance payload and/or data relating to the function of the housing, surveillance payload and/or surveillance balloon. The user interface may be further adapted to store data and display it to the user upon request. According to some embodiments of the present invention, an existing user interface, such as a PDA (personal digital assistant), may be adapted to perform the functions of the user interface described in the present disclosure.

The displayed data may be received by the user interface communication module, processed by the user interface processing circuitry (an example of which can be seen in FIG. 6A) and then displayed on the user interface display. The processing of the data by the user interface processing circuitry may include; (i) editing and correction for viewing, such as stabilization or orientation of an image; (ii) correlation and comparison of different forms of data or of data from different times, such as combining positional data or audio data with an image; (iii) magnification; (iv) comparison and/or integration of data received from different surveillance balloons; (v) comparison and/or integration of related data stored on the user interface database; (vi) image recognition, such as motion, people or object detection; and/or (vii) any other data processing which may assist in surveillance. The processing of the data may be done automatically and/or by user command. According to some embodiments of the present invention, some of the data processing may be done by processing circuitry located in the surveillance payload (an example of which can be seen in FIG. 5A), prior to transmission to the user interface, possibly in conjunction with appropriate movement sensors, such as an accelerometer. The interface processing circuitry may be further adapted to receive commands from a user via the interface assembly and may be yet further adapted to relay user commands to the housing and/or surveillance payload via the interface communication module. According to further embodiments of the present invention, the interface processing circuitry may be further adapted to transmit and receive, via the interface communication module, data from/to other user interfaces and/or one or more central control/command modules. The interface processing circuitry may also be adapted to store received data on the database. According to yet further embodiments of the present invention, the user interface database may be pre-programmed with and/or receive related data from other sources, which data may be presented on the interface display separately, alongside and/or in integration with the data collected by the sensors. The pre-programmed and/or received data may include maps, satellite images, topographical data and/or any other related data.

According to further embodiments of the present invention, there may be provided an anchor line (examples of which can be seen in FIGS. 1, 2, 5A & 7(E-G)) anchoring the surveillance balloon and payload to the housing. According to some embodiments of the present invention, the anchor line may be up to 100 meters long and may have an adjustable length. Furthermore, a motor may be provided, which motor may be adapted to shorten/lengthen the anchor line after deployment, allowing for control of the elevation of the surveillance balloon and payload while these are airborne.

According to yet further embodiments of the present invention, the anchor line may further include wiring to carry power and/or data from the housing to the surveillance payload and/or vice versa. Accordingly, in some embodiments of the present invention including an anchor line, the surveillance payload may not require one or more of the following components: (i) a power source; (ii) control circuitry; and/or (iii) a wireless communication module. Thus, according to some embodiments of the present invention including an anchor line: (i) the surveillance payload may receive power from the housing canister power source; (ii) the canister control circuitry may be adapted to control aspects of the payload's and/or sensors' operation, electrical and mechanical components of the surveillance payload and/or inflation and deflation of the surveillance balloon; and/or (iii) the canister communication module may transmit data received from the surveillance payload, via the anchor line, to a user interface and/or a remote monitoring station. According to yet further embodiments of the present invention including an anchor line, the anchor line may also include a gas line adapted to allow further inflation of the surveillance balloon after deployment.

According to some embodiments of the present invention including an anchor line, data generated by circuitry within the housing may be transmitted to the interface via an antenna situated on the balloon. A transmitter circuit/module for the housing data may be located either at the housing or on the balloon. According to embodiments where the transmitter circuit/module is on the balloon, the housing data may be sent to the balloon in baseband.

According to yet further embodiments of the present invention, including an anchor line, the anchor line may be adapted to serve as a transmitting and/or receiving antenna, for the housing communication module and/or the payload communication module.

According to yet further embodiments of the present invention, the housing may also comprise a flash charge (an example of which can be seen in FIG. 3A) adapted to discharge upon deployment of the surveillance balloon. The flash charge may be an explosive designed to create a loud noise and/or a bright flash of light upon explosion.

According to further embodiments of the present invention, the surveillance payload may further comprise one or more mechanical and/or electric maneuvering devices adapted to maneuver sensors and/or the surveillance balloon. The maneuvering device(s) may be controlled by the payload control circuitry and/or the housing control circuitry according to pre-programmed guidelines and/or commands received from the user interface, which commands may be automatically generated and/or input by a user.

According to yet further embodiments of the present invention, the housing may be adapted to be launched by a launcher, such as a grenade launcher.

According to some embodiments of the present invention, the surveillance balloon, surveillance payload and housing may be disposable. According to further embodiments of the present invention, the surveillance balloon, surveillance payload and/or housing may be reusable. Reuse, may involve replacement, recalibration, recharging and/or refilling of one or more components of the apparatus.

It should be understood by one of skill in the art that some of the functions described as being performed by a specific component of the system may be performed by a different component of the system in other embodiments of this invention.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

### Exemplary Embodiments

In the following exemplary embodiments, only a portion of the numerous possible implementations of the present invention are set forth, in order to further elucidate the present invention. Therefore, the description presented in the following exemplary embodiment does not and should not be considered to encompass the possible implementations of the present invention in any way.

An aspect of some embodiments of the invention relates to providing a device comprising a surveillance balloon and a housing, the surveillance balloon adapted to be packaged inside the housing, and further adapted to be deployed from the housing while the device is tossed into the air. The device, together with a monitor adapted to display information acquired by the surveillance balloon, are comprised in a surveillance system adapted to allow a user which may be, for example, a soldier or a counter-insurgency fighter or a policeman, to view areas where a user's sight may be obstructed. Such areas may include, for example, areas behind walls, behind barricades, inside rooms, behind corners, at junction turns, and the like.

According to an aspect of some embodiments of the invention, the device is adapted to be carried by a user and is further adapted to be tossed into the air over a distance, for example, as is done with a grenade. The device is relatively lightweight, weighing between 100 grams-1000 grams, for example, 400-600 grams when un-deployed, and may be tossed a relatively long distance, for example, 25-50 meters using one hand. When deployed, the surveillance balloon may weigh between 10-100 grams, for example, 20-70 grams. Prior to throwing the device into the air, the user may set a time delay mechanism and/or may remove a safety pin. Once thrown into the air, a safety lever may be released initiating the delay mechanism such that, after a preset delay time, the surveillance balloon may be deployed. Optionally, the device may be launched into the air by other modes of propulsion such as, for example, a launcher, such as may be used for launching explosive grenades, smoke grenades, tear gas canisters, and the like; or a deployment mechanism in the device comprising an acceleration detector and/or an impact detector, or the like. Optionally, the surveillance balloon may be deployed while the device is on the ground (not in the air). Optionally, the surveillance balloon may be deployed after an unspecified period of time by remote control from a remote monitoring device.

Deployment of the surveillance balloon is done by filling a balloon with a lighter-than-air gas, such as, for example, helium, comprised in a gas container inside the housing. The gas is adapted to keep the surveillance balloon, which includes a payload, afloat in air. The payload is adapted to detach from within the housing and remain suspended from the balloon as the housing drops to the ground. As the gas flows into the balloon, the balloon may force open a lid on the housing, and may slide out of the housing, where it may continue to fill to a predetermined size. Optionally, the balloon may be filled with a gas emitted from a chemical reaction inside the device, for example, a gas such as hydrogen. The gas may be produced by combining relevant materials, which are separately stored inside the housing. Optionally, the balloon may comprise a lighter-than-air gas, which may be compressed inside the balloon as the balloon is compressively stored inside the housing, the gas adapted to expand as the balloon is deployed from the housing. Optionally, the housing may include pressure and temperature checking probes adapted to automatically determine an amount of gas to fill the balloon. The amount of gas may be influenced by parameters such as temperature changes, ground altitude changes, ambient pressure changes, and the like.

Optionally, the lid may be opened by a release mechanism. Optionally, the release mechanism may be actuated responsive to a command signal received from a micro-controller (controller) adapted to control functions associated with deployment of the surveillance balloon.

In an embodiment of the invention, the surveillance balloon comprises an inflatable balloon; a payload including a camera adapted to record still images and/or video images; a compass to provide the user with an indication of heading, for example the direction north; and a transmitter adapted to transmit the images, compass heading, optional audio, and other information by wireless RF (radio frequency) to a portable monitor carried by the user. Optionally, the monitor may be stationary. Optionally, wireless RF may include, for example, a wireless local area network (WLAN) such as WiFi, WPAN, WiMAX, MBWA, and/or WRAN, or any combination thereof. Additionally or alternatively, the payload may include a tilt sensor and/or other type of gravity heading sensor. For convenience hereinafter, images, audio, compass heading information, and other information which may be transmitted from the device to the monitor, may be referred to as “data”. Optionally, the monitor may be adapted to transmit control information to the device by wireless RF (radio frequency). Optionally, the data may be stored in the monitor to be used, for example, for further inspection.

The camera may be an IR (infrared) camera, an InGaAs (indium gallium arsenide) camera, a CCD (charge coupled device) camera, or other type of imaging device adapted to acquire an image, such as, for example, an RF detector, an acoustic detector, and the like. Optionally, the camera may comprise an IR camera adapted to emit an IR beam which may be seen by the camera. The camera may be adapted to capture up to a 360 degree view of the area below the balloon. Optionally, the camera may be adapted to capture up to a 360 degree view of the area above, and/or laterally to, the surveillance balloon. Optionally, the payload may include a microphone or other type of device adapted to capture audio, which may be transmitted to the monitor and/or other type of audio reception device. Optionally, the payload may include a circuitry adapted to indicate to the user a position of the surveillance balloon.

The time delay mechanism comprises a mechanical timer which is set by the user by rotating a knob to one of several positions, the positions associated with predetermined delay times. Optionally, the timer may be adapted to be set to any delay time ranging from 0 seconds to a maximum predetermined delay time. Optionally, the time delay mechanism may include a counter in the controller which may be set by rotating the knob. Additionally or alternatively, the delay time is preprogrammed into the controller. Optionally, the delay time is set by pushbuttons on the device and/or on the monitor. Optionally, the time delay mechanism may be set by other means, for example, by sliding a lever. Additionally or alternatively, the delay time is displayed on the device, for example, on a LED (light emitting diode) display. Optionally, the delay time is displayed on the monitor.

The controller may be adapted to control functions associated with deployment of the surveillance balloon. Responsive to lapsing of the delay time, which may be associated with an electrical signal received from the timer mechanism, or optionally, the internal counter in the controller, the following actions may be performed by the controller:
a. Send a control signal to the optional release mechanism of the lid opening the lid.
b. Send a control signal to open a valve in the gas container to allow flow of gas into the balloon. Optionally, the control signal is used to initiate a chemical reaction which produces the gas for filling the balloon.
c. Send a control signal to release a locking mechanism disengaging the payload from the housing, the locking mechanism adapted to secure the payload to an inside of the housing. For example, the locking mechanism may include the use of safety pins which are released. Optionally, release of the locking mechanism may be triggered by a drop of pressure in the gas container as the gas starts to flow into the balloon.
d. Send a control signal activating payload components' camera and transmitter/compass, and/or the optional tilt sensor. Optionally, the controller may activate all or some of payload components prior to lapsing of the delay time. Optionally, the controller may activate energy charging of a capacitive element in the payload from an energy source such as, for example, a battery, in the housing.

Optionally, the controller may comprise electromechanical switching to perform some or all of the above actions. Optionally, the controller may be partially, or fully mechanical, and may include mechanical switching to perform some or all of the above actions. Optionally, the signal received from the timer mechanism and associated with lapsing of the delay time may be a mechanical signal.

According to some embodiments, the device for deploying the surveillance balloon may be water and/or contaminant (for example dust) sealed. According to additional or alternative embodiments, the device for deploying the surveillance balloon may be shock proof, particularly when the balloon is inside the housing before deployment, to allow the device to be carried or stored at harsh conditions (such as vibrations, hitting against other objects or the like), without being damaged and without being unintentionally released (deployed).

There is provided, in accordance with an embodiment of the invention, a device for deploying a surveillance balloon, the device comprising a housing adapted to package the surveillance balloon, and a time delay mechanism adapted to trigger a deployment of the balloon from the housing upon lapsing of a delay time. Optionally, the device is a hand held device. Optionally, the device is adapted to be hand thrown into the air in proximity to an area, which requires surveillance.

There is provided, in accordance with an embodiment of the invention, a surveillance system comprising a device for deploying a surveillance balloon, the device comprising a housing adapted to package the surveillance balloon, a time delay mechanism adapted to trigger a deployment of the balloon from the housing after lapsing of a delay time, and a monitor adapted to receive data from the surveillance balloon. Optionally, the monitor is further adapted to record and transfer the data. Optionally, the monitor is further adapted to analyze and correct the data for viewing. Additionally or alternatively, the device for deploying the surveillance balloon is a hand held device. Optionally, the device is adapted to be hand thrown into the air in proximity to an area, which requires surveillance.

There is provided, in accordance with an embodiment of the invention, a device for deploying a surveillance balloon, the device comprising a housing adapted to package the surveillance balloon and a time delay mechanism adapted to trigger a deployment of the balloon from the housing upon receiving a command signal from a remote user. Optionally, the device is a hand held device. Optionally, the device is adapted to be hand thrown into the air in proximity to an area which requires surveillance.

In some embodiments of the invention, the surveillance balloon is associated with a data acquisition device. Optionally, the data acquisition device comprises an imaging device adapted to acquire an image. Optionally, the imaging device is a camera. Additionally or alternatively, the surveillance balloon is further associated with a transmitter adapted to transmit data to a remote user. Optionally, the data comprises one or more images, videos or both.

In some embodiments of the invention, the surveillance balloon comprises a sensor device adapted to indicate a position and/or a heading. Optionally, the sensor device comprises a compass. Optionally, the surveillance balloon comprises a DC power source. Optionally, the surveillance balloon comprises a power capacitor.

In some embodiments of the invention, the surveillance balloon comprises a gas-inflatable balloon adapted to float the surveillance balloon in the air. Optionally, triggering the deployment of the surveillance balloon is associated with inflating the balloon with gas. Additionally or alternatively, the device further comprises a gas container adapted to hold a gas, wherein the gas is adapted to inflate the balloon. Optionally, the balloon comprises a compressed gas. Optionally, the balloon is inflated by a gas produced by a chemical reaction. Optionally, the gas is a lighter-than-air gas. Optionally, the gas comprises helium. Optionally, the gas comprises hydrogen. Optionally, the device further comprises a pressure and/or temperature checking probe adapted to automatically determine an amount of gas to fill the balloon.

In some embodiments of the invention, the device further comprises a controller adapted to control the time delay mechanism and/or one or more other functions associated with deployment of the surveillance balloon. Optionally, the controller comprises a mechanical part.

In some embodiments of the invention, the time delay mechanism comprises a delay set knob. Optionally, the delay set knob comprises a delay reference point. Optionally, the time delay mechanism comprises at least one delay set bar.

In some embodiments of the invention, the device further comprises a safety lever adapted to activate the time delay mechanism upon the release of the safety lever. Optionally, the device further comprises a safety pin adapted to prevent the safety lever from activating the time delay mechanism. Optionally, the safety lever comprises a spring adapted to eject the safety lever.

In some embodiments of the invention, the device further comprises a locking mechanism adapted to hold the surveillance balloon fixed inside the housing.

There is provided, in accordance with an embodiment of the invention, a method for deploying a surveillance balloon, the method comprising providing a device for deploying a surveillance balloon; triggering a time delayed deployment of the surveillance balloon from a housing; and hand throwing the device into the air in proximity to an area which requires surveillance. Optionally, the method further comprises acquiring data from the surveillance balloon. Optionally, the data comprises one or more images, videos or a combination thereof.

In some embodiments of invention, triggering the time delayed deployment of the surveillance balloon is associated with inflating the balloon with gas. Optionally, the gas is a lighter-than-air gas. Optionally, the gas comprises helium. Additionally or alternatively, the method further comprises releasing a safety lever to activate the delayed deployment of the surveillance balloon.

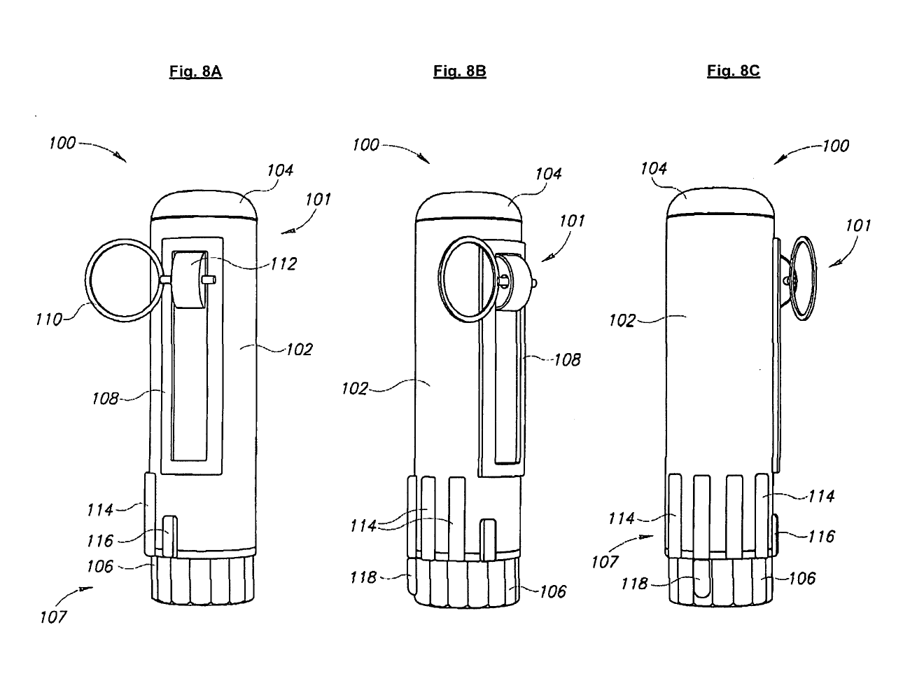

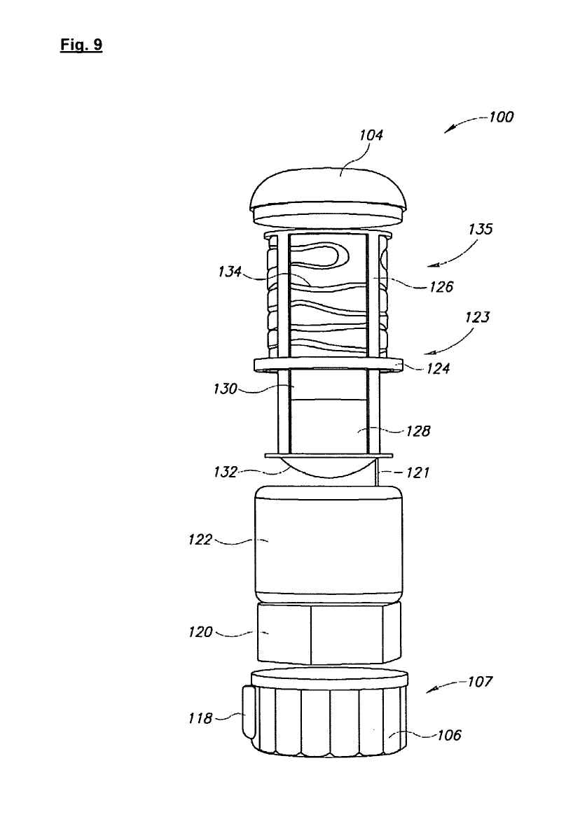

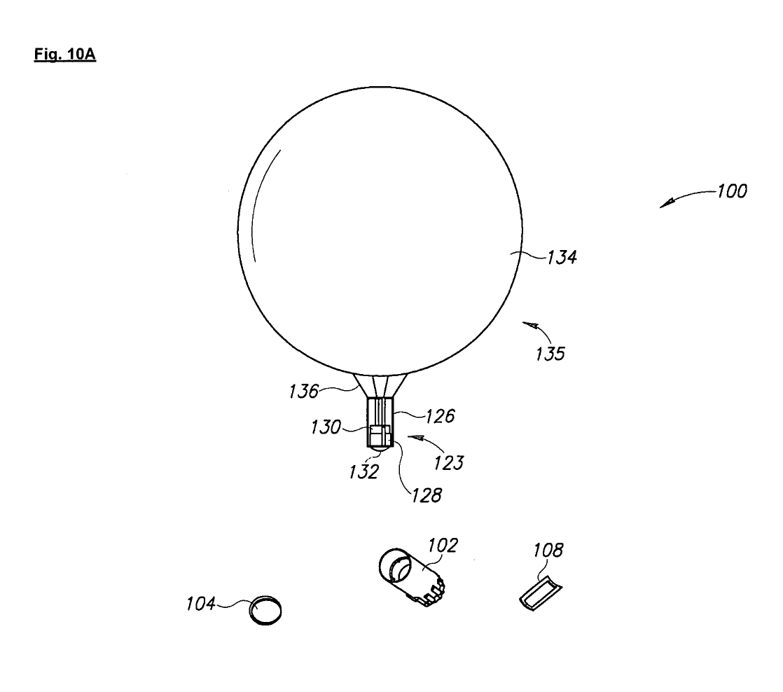

The Exemplary embodiments of the invention described above will now be described with reference to FIG. 8-12. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale.

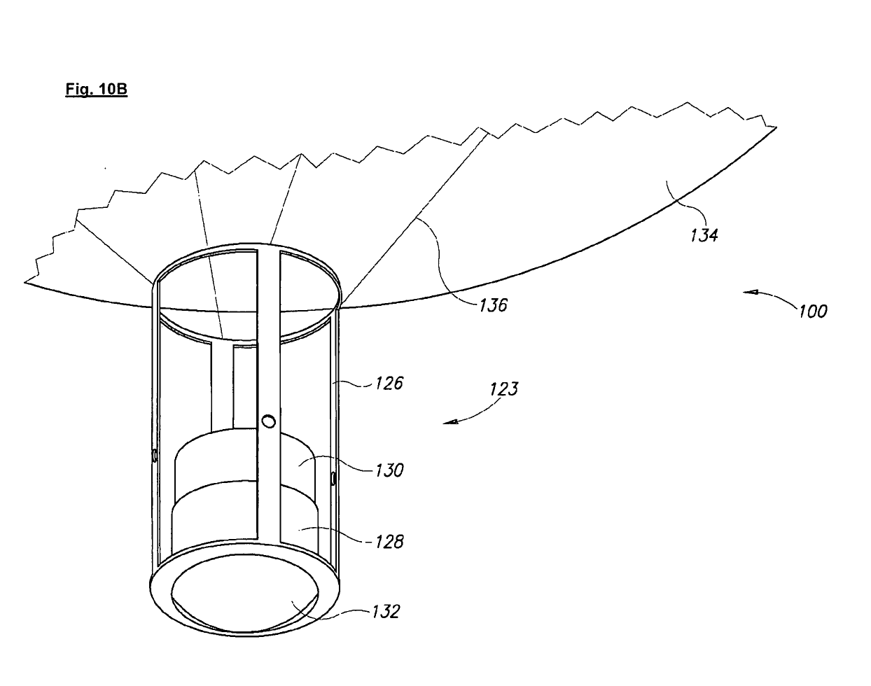

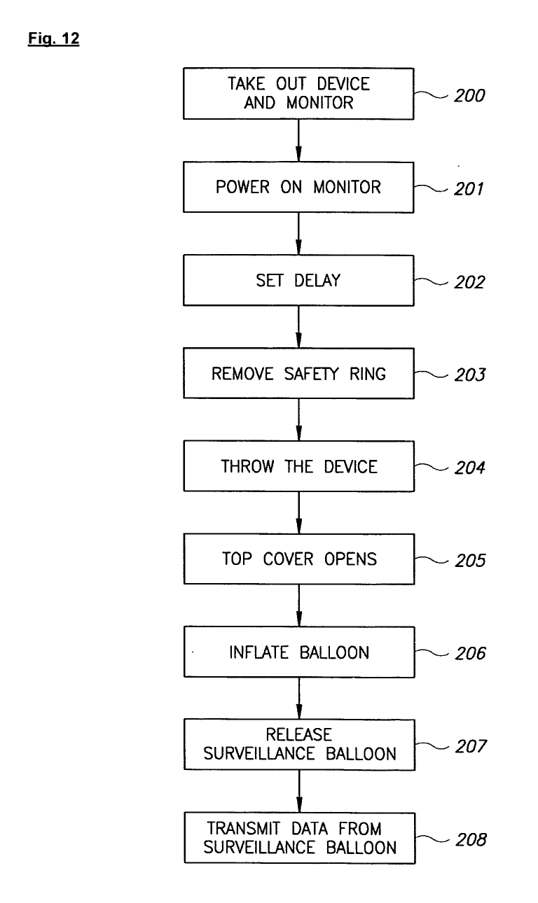

Reference is made to FIGS. 8A, 8B and 8C which schematically show different isometric views of a device 101 comprised in a surveillance system 100, and to FIG. 11 which schematically shows an isometric view of a monitor 140 comprised in surveillance system 100, all in accordance with an embodiment of the invention. Reference is also made to FIG. 9 which schematically shows an isometric view of components comprised in device 101; in accordance with an embodiment of the invention.

Surveillance system 100 is adapted to allow a user, which may be, for example, a soldier, a counter-insurgency fighter, a policeman, search and rescue personnel, and/or homeland security personnel and or a robot or a remotely controlled equipment, to view areas where user sight may be obstructed. Such areas may include, for example, areas behind walls, behind barricades, inside rooms, behind corners, at junction turns, behind natural obstacles such as trees and boulders and the like.

In accordance with an embodiment of the invention, in FIGS. 8A, 8B & 8C a device such as device 101 comprises a small surveillance balloon such as surveillance balloon 135 including a balloon such as balloon 134, shown deflated, and a payload such as payload 123 comprising a camera such as camera 128 and a transmitter/compass such as transmitter/compass 130; and a housing such as housing 102. Surveillance balloon 135 is adapted to be packaged inside housing 102, and is further adapted to be deployed from the housing 102 while device 101 is tossed into the air over a distance, somewhat resembling the manner in which a grenade is thrown. Prior to throwing device 101 into the air, a time delay mechanism is set and a safety pin such as safety pin 110 may be removed from a safety lever such as safety lever 112. When device 101 is thrown into the air, safety lever 112 is released, initiating the delay mechanism so that, after a preset delay time, surveillance balloon 135 may be deployed. Deployment of surveillance balloon 135 is done by filling balloon 134 with a lighter-than-air gas, such as, for example, helium, comprised in a gas container such as gas container 122 which may be situated inside housing 102. The gas is adapted to keep surveillance balloon 135 afloat in the air, balloon 134 may further comprise a valve (not shown) adapted to keep the gas from escaping. Control of the deployment process may be performed by a controller such as controller 120. A monitor such as monitor 140 is adapted to display to the user data acquired by deployed surveillance balloon 135 and transmitted from the surveillance balloon through wireless RF to the monitor, and may be optionally adapted to send control signals, for example, through wireless RF, to device 101. Optionally, wireless RF may include, for example, a wireless local area network (WLAN) such as WiFi, WPAN, WiMAX, MBWA, and/or WRAN, or any combination thereof. Optionally, the data may be stored in the monitor to be used, for example, for further inspection.

Housing 102 may be made from a relatively strong lightweight material, for example aluminum metal, the canister shaped such that device 101 may be held using one hand of and may be relatively easily tossed into the air. For example, housing 102 may be shaped as a cylindrical tube as shown in FIGS. 8A, 8B & 8C although housing 102 may optionally comprise other shapes, for example, spherical, polyhedral, and the like. Housing 102 may be optionally made from other types of metals, metal alloys, plastic, composite materials, or any combination thereof. With housing 102 shaped cylindrically as shown, device 101 may weigh between 100-1000 grams, for example, 400-600 grams when un-deployed, with surveillance balloon 135 inside, and may be tossed over a relatively long distance such as, for example, 25-50 meters, using one hand. When deployed, surveillance balloon 135 may weigh between 10-100 grams, for example, 20-70 grams. Optionally, device 101 may be launched into the air by other modes of propulsion such as, for example, a launcher, such as that used for launching explosive grenades, smoke grenades, tear gas canisters, and the like. Deployment of device 101 may optionally comprise an acceleration detector and/or an impact detector, or the like.

Housing 102 is fitted with a lid such as lid 104 adapted to keep the components inside device 101 while housing 102 is in the air, the lid further adapted to disengage (detach or open) from housing 102 when surveillance balloon 135 is being deployed. Lid 104 may disengage from housing 102 by a force exerted on the lid by balloon 134 as the balloon is filled with gas from gas container 122 through a gas line such as gas line 121. Optionally, balloon 134 may be filled with a gas emitted from a chemical reaction inside device 101, for example, a gas such as hydrogen. The gas may be produced by combining relevant materials which are separately stored inside housing 102. Optionally, balloon 134 may comprise a lighter-than-air gas which may be compressed inside the balloon as the balloon is compressively stored inside housing 102, the gas adapted to expand as the balloon is deployed from housing 102. Optionally, housing 102 may include pressure and temperature checking probes (not shown) adapted to automatically determine an amount of gas to fill balloon 134. The amount of gas may be influenced by parameters such as temperature changes, ground altitude changes, ambient pressure changes, and the like.

Optionally, lid 104 may be opened by a release mechanism (not shown) inside, or optionally outside, housing 102. Additionally or alternatively, the release mechanism may be actuated responsive to a command signal received from controller 120.

In accordance with an embodiment of the invention, device 101 comprises a time delay mechanism such as time delay mechanism 107 adapted to trigger opening of a flow of the lighter-than-air gas from gas container 122 into balloon 134, following a predetermined delay time. Time delay mechanism 107 may send an electrical signal opening an electromechanical valve (not shown) in gas container 122. Optionally, time delay mechanism 107 may mechanically initiate a mechanism to open the valve in gas container 122. Optionally, time delay mechanism 107 may send an electrical signal to controller 120, the controller responding by sending a command signal to the electromechanical valve in gas container 122. Time delay mechanism 107 comprises a delay set knob such as delay set knob 106 which may be a mechanical timer, and which may be set by the user by rotating the knob to one of several delay set bars such as delay set bar 114 and aligning a delay reference point such as delay reference point 118 on the knob with a set bar. Each set bar 114 may be associated with a predetermined delay time such as, for example, 1 second, 2 seconds, 2.5 seconds, and the like. Optionally, delay set knob 106 may be set to any delay time ranging from 0 seconds to a maximum predetermined delay time, the maximum delay time indicated by delay set bar 116. Optionally, delay set bar 116 may indicate the minimum delay time. Optionally, delay set knob 106 may be used to set a counter in controller 120, the counter adapted to count the delay time. Optionally, time delay mechanism 107 may be set by pushbuttons on device 101. Optionally, the delay timer mechanism may be set through monitor 140. Optionally, time delay mechanism 107 is set by other means, for example, by sliding a lever. Optionally, time delay mechanism 107 may be set through monitor 140. Optionally, the delay time is displayed on device 101, for example, on an LED (light emitting diode) display. Optionally, the delay time is displayed on monitor 140. Additionally or alternatively, the user remotely triggers opening of gas container 122 through monitor 140.

In accordance with an embodiment of the invention, time delay mechanism 107 is activated by the release of safety lever 108. Safety lever 108 may comprise a spring loaded mechanism 112 which is held in place by safety pin 110. Removal of safety pin 110 causes spring loaded mechanism 112 to eject safety lever 108 away from housing 102, the action resulting in the activation of time delay mechanism 107. Activation may be by an electrical signal sent to time delay mechanism 107, and/or optionally, by a mechanical action exerted on the time delay mechanism. The user, when holding device 101 in one hand and safety pin 110 is removed, is required to hold safety lever 108 in place in order to prevent the activation of the time delay mechanism. Upon tossing device 101 into the air, spring lever 108 is released, activating time delay mechanism 107. Optionally, time delay mechanism 107 is activated by pressing a button on device 101, following removing safety pin 110, adapted to prevent pressing of the button. Optionally, pressing of the button is possible only after the button is rotated. Optionally, the button may be pressed after some other mechanism adapted to prevent the button from being pressed, is released.

In accordance with an embodiment of the invention, controller 120 is adapted to control functions associated with deployment of surveillance balloon 135. Responsive to lapsing of the delay time, which may be associated with an electrical signal received from the timer mechanism, or optionally, the internal counter in controller 120, the following actions may be performed by the controller:
a. Send a control signal to the optional release mechanism of lid 104 opening the lid.
b. Send a control signal to open the valve in gas container 122 to allow flow of gas into balloon 134. Optionally, the control signal is used to initiate a chemical reaction which produces the gas for filling balloon 134.
c. Send a control signal to release a locking mechanism such as locking mechanism 124, for example by releasing safety pins (not shown), disengaging payload 123 from housing 102, the locking mechanism adapted to secure the payload to the inside of housing 102. Optionally, release of locking mechanism 124 may be triggered by a drop of pressure in gas container 122 as the gas starts to flow into balloon 134.
d. Send a control signal activating payload 123 components camera 128 and transmitter/compass 130, and/or an optional tilt sensor (not shown) or other gravity sensor device. Optionally, controller 120 may activate all or some of payload 123 components prior to lapsing of the delay time. Optionally, controller 120 may activate energy charging of a capacitive element (not shown) in payload 123 from an energy source (not shown) such as, for example, a battery, in housing 102.

Device 101 may comprise a DC (direct current) power source (not shown) such as, for example, a replaceable battery, the DC power source adapted to provide direct current to controller 120 and time delay mechanism 107. Optionally, the battery may be rechargeable, for example, by connecting to an external charging device. Optionally, direct current may also be provided to the valve in gas container 122 and/or the release mechanism for lid 104 and/or the safety pins in locking mechanism 124. Optionally, the DC power source may be comprised in payload 123. Optionally, controller 120 may comprise electromechanical switching to perform some or all of the above actions. Optionally, controller 120 may comprise mechanical switching to perform some or all of the above actions.

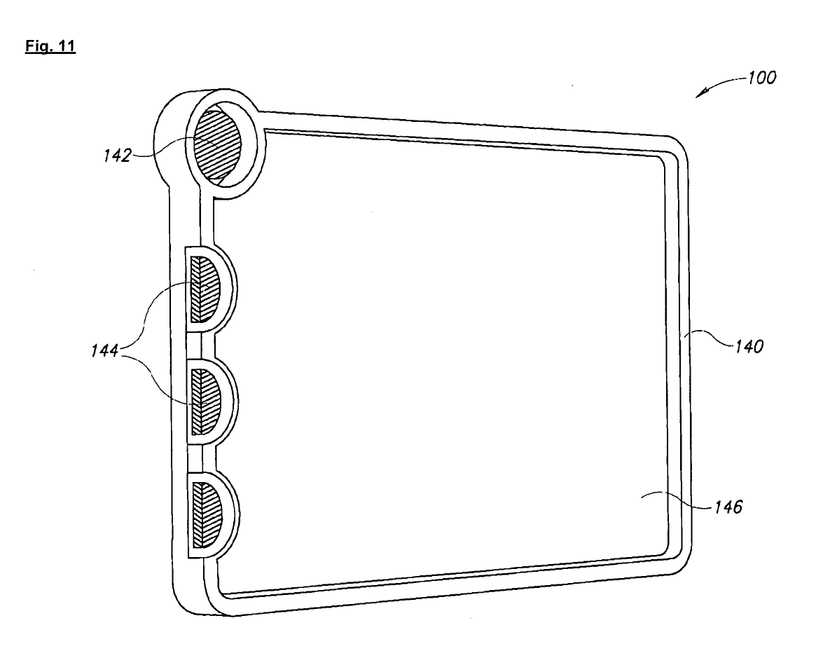

Reference is also made to FIG. 10A which schematically shows an isometric view of device 101 following deployment of surveillance balloon 135, and to FIG. 10B which shows a detailed isometric view of payload 123, all in accordance with an embodiment of the invention. Payload 123 comprises a structural frame such as frame 126 which may be a housing, adapted to hold the payload components, and further adapted to be pulled out of housing 102 and suspended from balloon 134 by a plurality of tie members such as tie members 136. Tie members 136, which may be, for example, strings made from natural fibers, synthetic fibers, wires, or any combination thereof, may be adapted to resist a tension created by a force of balloon 134 pulling on frame 126. Release of the safety pins in locking mechanism 124 may disengage frame 126 from housing 102, such that payload 123 may be pulled out by balloon 134 as housing 102 drops to the ground. Other components which may disengage from housing 102 may also separately drop to the ground such as, for example lid 104 and/or safety lever 108. Optionally, lid 104 and/or safety lever 108, may be connected to housing 102 by a string or a wire, dropping to the ground attached to housing 102. Balloon 134 may be made from a material such as, for example, rubber, plastic, metalized plastic, nylon, aluminum foil, PVC, fabric, tarpaulin, composite materials, and/or any combination of materials suitable for the balloon.

Camera 128 is adapted to record still images and/or video images. Camera 128 may be an IR (infrared) camera, an InGaAs (indium gallium arsenide) camera, a CCD camera, or other type of imaging device which may be adapted to acquire an image in a lit background, and optionally dark background. Optionally, camera 128 may comprise a detector to acquire images, such as for example, an RF detector, an acoustic detector, and the like. Optionally, camera 128 may comprise an IR camera adapted to emit an IR beam which may be seen by the camera. Camera 128 may be further adapted to capture up to a 360 degree view of the area below surveillance balloon 135 through a lens 132. Optionally, camera 128 may be adapted to capture up to a 360 degree view of the area above, and/or laterally to, surveillance balloon 135.

Transmitter/compass 130 comprises a compass to provide the user with an indication of heading, for example, a direction north; and a transmitter adapted to transmit by wireless RF all data acquired by surveillance balloon 135 to monitor 140. Although shown in the figure as one unit, optionally transmitter/compass 130 may comprise two separate units, one the transmitter and a second unit the compass. Optionally, transmitter/compass 130 comprises the tilt sensor or other gravity heading sensor. Optionally, payload 123 may include a microphone or other type of device adapted to capture audio, which may be transmitted to monitor 140 and/or other type of audio reception device. Optionally, payload 140 may include a circuitry adapted to indicate to the user a position of surveillance balloon 135. Optionally, payload 123 may include a receiver adapted to receive through wireless RF control signals for manipulating camera 128 from monitor 140.

Payload 123 additionally comprises a DC (direct current) power source such as, for example, a battery, the DC power source adapted to provide direct current to camera 128 and transmitter/compass 130. The battery may be replaceable or optionally, rechargeable from an external battery charging device. Optionally, payload 123 comprises a capacitive element (capacitor) adapted to store a charge from the DC power source in payload 123. Additionally or alternatively, the power source may be situated in housing 102. Optionally, direct current may also be provided to controller 120, timer delay mechanism 107, the valve in gas container 122, the optional release mechanism for lid 104, and/or the safety pins in locking mechanism 124.

Monitor 140 is a portable unit adapted to be carried by the user in a single hand, resembling in size a personal digital assistant (PDA), and further adapted to display on an LCD (liquid crystal display) 146 data acquired by surveillance balloon 135 and sent through wireless RF. Optionally, the data is displayed on an LED (light emitting diode) display. Optionally, monitor 140 may display the data acquired from a plurality of surveillance balloons 135. Monitor 140 may be further adapted to store the data and to play back the data. Optionally, the data may be transferred using a plug-in device such as, for example, USB, and/or by other connection methods which may include, for example, wireless RF and/or infrared, to devices such as lap-top computers, other PDA devices, desk top computers, and other data processing/storage devices, adapted to store and/or play back the data. Monitor 140 may comprise control buttons such as, for example, a power switch 142 adapted to turn the monitor on/off, and operations buttons 144 adapted to manipulate the received data. Optionally, monitor 140 may be further adapted to send control signals through wireless RF to device 101 and/or surveillance balloon 135. Optionally, monitor 140 may be adapted to send control signals to a plurality of devices 101 and/or surveillance balloons 135. Optionally, operation buttons 144 may be used to control monitor 140 for sending the control signals. Additionally or alternatively, monitor 140 may comprise a speaker through which audio acquired by surveillance balloon 135 may be heard. Optionally, monitor 140 may be adapted to allow the user to connect a headset to listen to the audio. Optionally, monitor 140 may be of a larger size resembling that of a laptop computer and/or may comprise a laptop computer. Optionally, monitor 140 may be the size of a desk top computer and/or may comprise a desk top computer, adapted to be transported in a vehicle. Optionally, monitor 140 may be stationary and/or may comprise a stationary desk top computer or a larger type of computer. Monitor 140 may be additionally adapted to analyze and correct the data received from balloon 134, such as, for example, removing vibrations and fixing wide angle distortion.

Reference is made to FIG. 12, which schematically shows a flow diagram of an exemplary method for operating surveillance system 100, in accordance with an embodiment of the invention. The method described is for a surveillance system 100 comprising one device 101 and one monitor 140. It should be clear to a person skilled in the art that the described method is for exemplary purposes only, and that there may be other ways in which surveillance system 100 may be operated, including the use of a plurality of devices 101 and/or monitors 140.
[STEP 200] User takes out a device 101 and a monitor 140.
[STEP 201] User powers on monitor 140 by pressing power switch 142 and adjust operations buttons 144 as necessary.
[STEP 202] User sets delay time by turning delay set knob 106 such that delay reference point 118 is aligned with one of the delay set bars 114. Optionally, reference point 118 is aligned with delay set bar 116.
[STEP 203] Hold device 101 in hand which will be used to toss the device, and remove safety ring 110 from the device with the other hand. Hold device 101 so that safety lever 108 cannot be ejected by the action of spring 112 when safety ring 110 is removed.
[STEP 204] Toss device 101 into area where sight is obstructed.
[STEP 205] Following lapse of delay time, the valve in gas container 122 may be opened and gas may start to flow through gas line 121 to balloon 134. As balloon 134 starts to fill, the balloon may force lid 104 open. Optionally, following the lapse of the delay time, the release mechanism of lid 104 may disengage from the lid.
[STEP 206] Balloon 134 continues to fill with gas sliding out of housing 102 through the opening left by the disengagement of lid 104. Balloon 104 may continue to fill to a predetermined size.
[STEP 207] Upon balloon 134 filling with gas to the predetermined size, safety pins in locking mechanism 124 may be released, enabling balloon 134 to pull out payload 123 while housing 102 drops to the ground. Camera 128 and transmitter/compass 130 may be activated.
[STEP 208] Surveillance balloon 135 may float to a top of a room or to a predetermined height. Optionally, the height of floating may be dependent on a ground altitude, ambient temperature, and atmospheric pressure. Data may be transmitted by wireless RF from surveillance balloon 135 to monitor 140.

1. A surveillance apparatus comprising:
a deployable balloon adapted to reside within a housing prior to deployment and further adapted to support a surveillance payload after deployment, said balloon being further adapted to automatically exit said housing during deployment; and
a deployment mechanism adapted to cause deployment of said balloon from said housing upon occurrence of a predefined condition.

2. The apparatus according to claim 1, wherein said balloon is conically shaped and includes stabilization fins.

3. The apparatus according to claim 1, wherein the appearance of said balloon is selected from the group of appearances consisting of: (a) transparent, (b) camouflaged, (c) disguised, and (d) masked.

4. The apparatus according to claim 1, wherein the predefined condition is the completion of a deployment initiating sequence, wherein the deployment initiating sequence includes one or more of the following events: (a) a user releasing a safety, (b) a user engaging a deployment initiating mechanism, (c) a user throwing said housing, (d) said housing being launched from a launcher, (e) impact detection, (f) acceleration detection, (g) the lapsing of a predefined delay, (h) the lapsing of a user selected delay, (i) a radio signal being received and (j) a pyrotechnic event.

5. The apparatus according to claim 1, wherein said deployment mechanism is functionally associated with one or more devices selected from the group consisting of (a) an accelerometer, (b) an impact detector/sensor, (c) a fixed timer, (d) an adjustable timer, (e) a deployment initiating mechanism, (f) a mechanical delay mechanism, (g) an electronic delay mechanism, (h) a safety mechanism, (i) a radio signal receiver, and (j) a pyrotechnic mechanism.

6. The apparatus according to claim 1, wherein said surveillance payload includes a sensor assembly comprised of at least one sensor and a payload communication module.

7. The apparatus according to claim 6, wherein said sensor assembly includes one or more sensors selected from the group consisting of: (a) image sensors, (b) thermal sensors, (c) audio sensors, (d) location sensors, (e) altitude sensors, (f) a compass and (g) motion sensors

8. The apparatus according to claim 7, wherein said payload communication module is adapted to transmit data collected by said sensors to a user interface directly or through a housing communication module.

9. The apparatus according to claim 6, wherein said surveillance payload further includes an illumination source.

10. The apparatus according to claim 1, further comprising an anchor line adapted to connect sadeployable balloon to said housing adeployment.

11. The apparatus according to claim 1, further comprising a housing of a size, shape and weight that can be held and thrown by a human using one hand.

12. The apparatus according to claim 1, further comprising a flash charge.

13. A surveillance system comprising:
a user interface device;
a deployable balloon adapted to reside within a housing prior to deployment and further adapted to automatically exit said housing during deployment, said balloon being further adapted to support a surveillance payload after deployment, wherein said payload includes a communication module adapted to communicate with said user interface device; and
a deployment mechanism adapted to cause deployment of said balloon from said housing upon occurrence of a predefined condition.

14. The system according to claim 13, wherein the predefined condition is the completion of a deployment initiating sequence, wherein the deployment initiating sequence includes one or more of the following events: (a) a user releasing a safety, (b) a user engaging a deployment initiating mechanism, (c) a user throwing said housing, (d) said housing being launched from a launcher, (e) impact detection, (f) acceleration detection, (g) the lapsing of a predefined delay, (h) the lapsing of a user selected delay, (i) a radio signal being received and (j) a pyrotechnical event.

15. The system according to claim 13, wherein said deployment mechanism is functionally associated with one or more devices selected from the group consisting of: (a) an accelerometer, (b) an impact detector/sensor, (c) a fixed timer, (d) an adjustable timer, (e) a deployment initiating mechanism, (f) a mechanical delay mechanism, (g) an electronic delay mechanism, (h) a safety mechanism (i) a radio signal receiver and (j) a pyrotechnical mechanism.

16. The system according to claim 13, wherein said surveillance payload includes a payload communication module and a sensor assembly, wherein said sensor assembly includes one or more sensors selected from the group consisting of (a) image sensors, (b) thermal sensors, (c) audio sensors, (d) location sensors, (e) altitude sensors, (f) a compass and (g) motion sensors.

17. The system according to claim 16, wherein said payload communication module is adapted to transmit data collected by said sensors to said user interface.

18. The system according to claim 16, wherein said surveillance payload further includes an illumination source.

19. The system according to claim 16, further comprising an anchor line connecting said deployable balloon to said housing.

20. The system according to claim 13, wherein said housing is of a size, shape and weight that can be held and thrown by a human using one hand.

21. The system according to claim 13, further comprising a flash charge.

22. The system according to claim 17, further comprising processing circuitry adapted to process said data collected by said sensors.
